(19) United States
(12) Patent Application Publication
(10) Pub. No.: US 2010/0232174 A1
(43) Pub. Date: Sep. 16, 2010

(54) Front Grill

(75) Inventors: Tetsuya Arakawa, Aichi-ken (JP); Akihiro Misawa, Aichi-ken (JP); Yoshiharu Tanaka, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 12/656,980

(22) Filed: Feb. 22, 2010

(30) Foreign Application Priority Data
Mar. 11, 2009 (JP) 2009-057392

(51) Int. Cl. B60Q 1/00

(52) U.S. Cl. 362/547; 362/546

(57) ABSTRACT

A vehicle front grill includes a grill main body and lamp housings that are integrally formed. A surface of the grill main body and surfaces of the lamp housings are coated with a single plating film, and light originating from the lamps accommodated in the lamp housings is reflected by the plating films of the lamp housings.

### BACKGROUND OF THE INVENTION

1. Field of the Invention

The present invention relates to an improvement on a front grill.

2. Description of the Related Art

A vehicle has a front grill provided for taking outside air for use with a radiator and an indoor air conditioner. The front grill is an important member not only in terms of such a practical facet but also of a design facet because the grill is equipped with the logo of a manufacturer and a characteristic shape for each of vehicle types. Meanwhile, lighting systems, such as DRLs (Daytime Running Lights), headlamps, turning indicators, and side marker lamps, are provided in the vicinity of the front grill. When such lighting systems are provided around the front grill of the vehicle, separate lamp housings are provided in the front grill. Patent Document 1 discloses a structure in which openings used for arranging lamps are provided in a front grill and in which separate lamps are fitted into the respective openings. Patent Document 2discloses a structure in which lamp mounting seats are provided at respective ends of a front grill and in which separate lamps are fastened to the respective lamp mounting seats with screws or clips. Patent Document 3 discloses a structure in which right and left head lamps are built from integrated lenses. Patent Document 4 discloses a structure that is not relevant to a front grill and that has lighting systems adjoining the right and left sides of a rear finisher. Patent Document 5 discloses a structure in which a front grill is equipped with lightning systems and in which letters, drawings, and the like, are displayed by means of indirect illumination. Patent Document 6 discloses, as example DRLs, a structure in which DRLs are built in respective head lamps as vehicle lighting systems.

Patent Document 1: Japanese Patent No. 3019738

Patent Document 2: JP-A-2001-213252

Patent Document 3: JP-A-2003-7106

Patent Document 4: JP-A-9-45111

Patent Document 5: JP-A-2008-105556

Patent Document 6: JP-A-2005-88856

According to the structure described in connection with Patent Document 1, the openings for lamps are formed, and separate lamps are fitted into the openings. For this reason, the number of components is large, and mounting operation becomes complicate. Further, the structure is disadvantageous in terms of cost. The structure described in connection with Patent Document 2 likewise requires separate lamps and hence is undesirable. The structure described in connection with Patent Document 3 also employs separate lamps that are fitted into right and left sides of a front grill and hence is undesirable. The structure described in connection with Patent Document 4 is a configuration in which vehicle lamps are provided adjacently on right and left sides of a rear finisher. The lamps are provided separately from the rear finisher and hence are undesirable. The structure described in connection with Patent Document 5 includes a front grill made of a transparent front panel and lamp units disposed behind the front panel. Each of the lamp units is made up of an exterior container having an indication sheet and a reflection surface that are bonded to a rear surface of the front panel and a light source that indirectly illustrates the indication sheet. Even in this structure, the lamp unit is provided separately from the front panel. Hence, the structure encounters problems of an increase in the number of components, complication of mounting operation, and an increase in manufacturing cost.

### SUMMARY OF THE INVENTION

Accordingly, the present invention aims at providing a front grill that is equipped with lamps and that achieves at least one of a reduction in the number of components, facilitation of mounting operation, and a reduction in manufacturing cost.

In order to achieve the object, the present invention has the following configuration; specifically, a vehicle front grill comprising a grill main body and lamp housings that are integrally formed, wherein a surface of the grill main body and surfaces of the lamp housings are coated with a single plating film; and light originating from the lamps accommodated in the lamp housings is reflected by the plating films of the lamp housings.

According to the front grill of the present invention, the grill main body and the lamp housings are integrally built. Hence, the number of components is diminished as compared with a case where lamp housings are separately provided. Since no clearance develops between the grill main body and the lamp housings, an aerodynamic advantage is yielded, and occurrence of wind noise, which would otherwise be caused during traveling of a vehicle, is prevented. Since the surface of the grill main body and the surfaces of the lamp housings are coated with a single plating film, plating of the surface of the grill main body and plating of the surfaces of the lamp housings can be performed simultaneously. Manufacturing processes can be simplified. Further, since the single plating film continually extends from the lamp housings to the grill main body, conduction of heat from the lamp housings to the grill main body is enhanced, whereby heat dissipating characteristics of the lamp units housed in the lamp housings are enhanced.

### BRIEF DESCRIPTION OF THE DRAWINGS

FIG. 1 is a front perspective view of a vehicle 10 having a front grill 1;

FIG. 2 is a front view of an area located in the vicinity of a DRL 3 of the front grill 1; and

FIG. 3 is a cross-sectional view taken along line A-A in FIG. 2.

### DESCRIPTION OF THE PREFERRED EMBODIMENTS

A front grill of the present invention has a grill main body and lamp housings in an integrated fashion. A material of the grill main body and the lamp housings can be determined in consideration of durability, weatherability, and moldability. For instance, an ABS resin, a polycarbonate resin, and the like, can be adopted. The grill main body can be formed by means of a known technique, such as injection molding. Different materials can also be molded in combination by means of two-color molding or the like. The lamp housings can be formed simultaneously with molding of the grill main body. The lamp housings can be provided at arbitrary positions on the grill main body in consideration of visibility, regulations, and the like. The surface of the grill main body and the surfaces of the lamp housings are coated with a single plating film. It is preferable to provide a substantially entire surface of the grill main body and a substantially entire surface of the lamp housings with the plating film. The reason for this is that conduction of heat from the lamp housings to the grill main body is enhanced, whereby a heat radiation characteristic of the lamp units is further enhanced. Technique pertaining to coating of a plating film is not particularly limited. However, adoption of wet plating treatment in consideration of workability is preferable. A material of the plating film is not particularly limited, so long as the material can reflect light from the lamp units to be described later. A material exhibiting high reflectance, such as chrome plating, is preferable. The reason for this is that a utilization factor of light form the lamp units is increased. It is desirable that the grill main body should have openings that are formed in a front of a vehicle and adjacent to lamp housings. Heat originating from the lamp units is dissipated by large amounts of outside air taken in from the openings during traveling of a vehicle, so that heat dissipating characteristics can be enhanced.

Lamps are accommodated in the lamp housings. Types of lamps are not particularly restricted, so long as the lamp can provide predetermined luminance. Known lamps, such as LED lamps, bulb lamps, and cathode-ray tubes, can be adopted. Of these lamps, adopting LED lamps as lamp units is preferable. The reason for this is that the LED lamps yield advantages, such as compactness, long operating life, and power saving. In the present invention, the lamps are provided in a limited area; namely, a front grill. Hence, use of compact LED lamps is preferable. When the lamps are used as DRLs to be described later, an illumination time is comparatively long; hence, use of LED lamps characterized by long operating life and power saving is further preferable.

The lamp housings assumes a shape that reflects light from the lamps accommodated in the lamp housings toward a predetermined direction by means of a plating film of the lamp housings. Specifically, the lamp housings act also as reflectors. Light originating from the lamps provided in the front grill of the present invention can be utilized for DRLs, headlamps, fog lamps, turning indicators, and the like. The term “DRL” referred to herein signifies a daytime lighting illumination system. The DRLs are illuminated in a time zone, or daytime hours, during which lighting is not required in normal times. The vehicle is thereby made conspicuous, to thus actively, early show presence of the vehicle to an ambient environment, such as oncoming cars and pedestrians, and prevent occurrence of an accident.

Each of the lenses is provided on a vehicle-front-side of each of the lamp housings and then sealed, whereby internal waterproof of the lamp housings can be kept. Assembly of the lamp units is not limited to this way. It may also be possible to produce lamp housings in such a way that only light emission sections of the lamp units project, in an exposed manner, from the lamp housings forward of the vehicle and seal clearance between the lamp housings and the lamp units, thereby making electrodes of the lamp units waterproof.

An embodiment of the present invention is hereinbelow described by reference to the drawings.

### First Embodiment

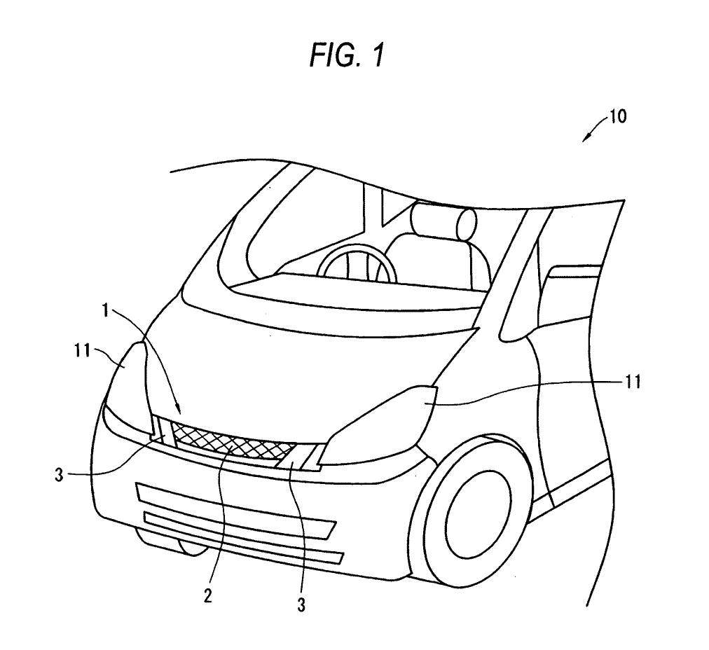

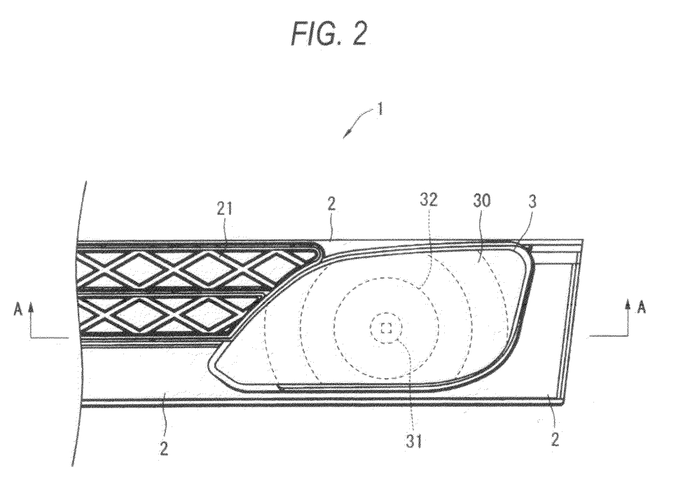

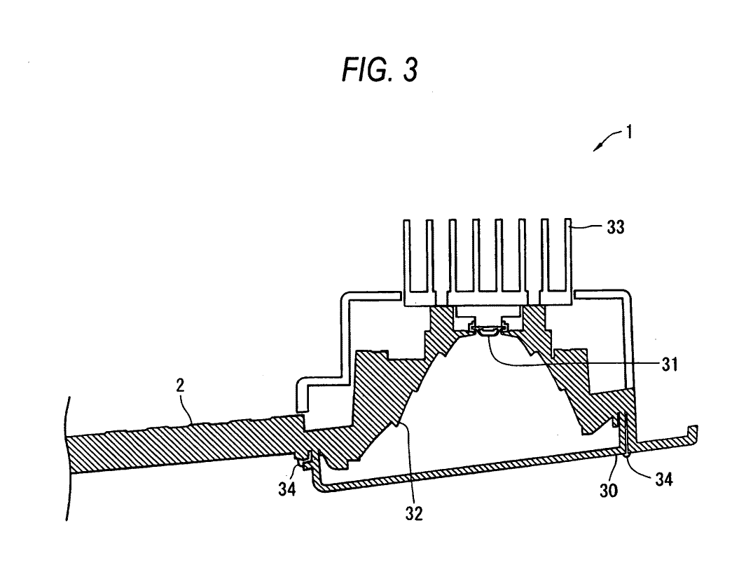

FIG. 1 is a front perspective view of a vehicle 10 having a front grill 1 of the present invention. The front grill 1 is mounted to an area between right and left headlamps 11 on a front part of the vehicle body of the vehicle 10. The front grill 1 has a grill main body 2 and DRLs 3. FIG. 2 shows a front view of a neighborhood of the DRL 3 of the front grill 1, and FIG. 3 shows the cross-sectional view taken along line A-A shown in FIG. 2. As shown in FIG. 2, the grill main body 2 has a mesh 21 opened in a grid pattern. The mesh 21 is provided along a longitudinal direction of the grill main body 2. The DRLs 3 are provided at right and left ends of the grill main body 2. Each of the DRLs 3 has a lens 30, an LED lamp 31 provided in the lens, and a lamp housing 32 housing the LED lamp 31. As shown in FIG. 3, the lamp housing section 32 is formed integrally with the grill main body 2. A chrome-plating film is formed over substantially-entire surfaces of the grill main body 2 and the lamp housing 32. The plating film is formed by wet plating technique. The lamp housings 32 house LED lamps 31, and surfaces of the lamp housing sections facing forward of the vehicle serve as reflection surfaces that receive light from the LED lamps 31, to thus reflect the light toward the front of the vehicle. A heat sink 33 is mounted on the rear of each of the LED lamps 31. The lens 30 is fitted to the grill main body 2 so as to cover the lamp housing 32. A sealing material 34 is sandwiched between an outer brim of the lens 30 and the grill main body 2, whereby internal waterproof of the lens 30 (i.e., an interior of each of the lamp housings 32) is maintained.

According to the front grill 1 of the present invention, the grill main body 2 and the lamp housings 32 of the DRLs 3 are integrally built. Hence, the number of components is diminished, and manufacturing cost can be curtailed. Ease of assembling operation is also enhanced. Since no clearance develops between the grill main body 2 and the lamp housings 32, an aerodynamic advantage is yielded, and occurrence of wind noise, which would otherwise be caused during traveling of a vehicle, is prevented.

Since the surface of the grill main body 2 and the surfaces of the lamp housings 32 are coated with a single plating film, plating of the surface of the main body and plating of the surfaces of the lamp housings can be performed simultaneously. As compared with a case where plating is performed on a per-component basis, manufacturing processes can be simplified. Further, since the single plating film continually extends from the lamp housings 32 to the grill main body 2, conduction of heat from the lamp housings 32 to the grill main body 2 is enhanced, whereby heat dissipating characteristics of the LED lamps 31 are enhanced. The plating film is formed by the wet plating technique and over a rear surface of the grill main body 2 and rear surfaces of the lamp housings 32. Heat originating from the LED lamps 31 can be dissipated to the outside by way of the rear surface of the grill main body 2 and the rear surfaces of the lamp housings 32, whereby a heat radiating characteristic is much enhanced. The mesh 21 is provided adjacently to the DRLs 3 on the grill main body 2. The mesh 21 is an inlet port for supplying outside air to a radiator, or the like. During traveling of the vehicle, a large amount of outside air passes through the mesh 21. The heat of the LED lamps 31 propagates to the grill main body 2 by means of the outside air, thereby being efficiently dissipated by way of the mesh 21. Thus, a high heat dissipation effect is yielded. As mentioned above, the plating film on the surface of the grill main body 2 and the surfaces of the lamp housings 32 are actively utilized for heat dissipation, whereby the heat dissipation characteristic of the LED lamps 31 is enhanced.

The front grill 1 of the present invention is provided with the DRLs 3. There is no necessity to assure a space on a vehicle chassis. Accordingly, the necessity for DRLs can be addressed by means of only replacing the front grill. Members other than the front grill can be communalized regardless of the necessity for the DRLs. Thus, the front grill of the present invention becomes advantageous in terms of a cost. All you need to provide an existing vehicle with DRLs is to replace an existing front grill with the front grill 3 of the present invention, and hence providing the DRLs becomes facilitated.

The front grill of the present invention can be utilized as a front grill for various vehicles.

What is claimed is:

1. A vehicle front grill, comprising:
a grill main body; and
lamp housings that are integrally formed with the grill main body;
wherein a surface of the grill main body and surfaces of the lamp housings are coated with a same plating film; and light originating from lamps accommodated in the lamp housings is reflected by the plating films of the lamp housings.

2. The front grill according to claim 1, wherein the surface of the grill main body and entire surfaces of the lamps are coated with the plating film.

3. The front grill according to claim 1, wherein the grill main body has an openings that are formed forwardly of a vehicle and that are adjacent to the lamp housings; and heat of the lamps is dissipated to the outside by way of outside air taken in from the opening.

4. The front grill according to claim 1, wherein the vehicle front grill is attached between left and right head lamps, and the head lamps are DRL.

5. The front grill according to claim 1, wherein the lamp housings are integrally formed with the front grill at right and left ends of the grill main body.
